(19) United States
(12) Patent Application Publication
(10) Pub. No.: US 2014/0177804 A1
(43) Pub. Date: Jun. 26, 2014

(54) X-RAY IMAGING APPARATUS

(71) Applicant: CANON KABUSHIKI KAISHA, Tokyo (JP)

(72) Inventors: Kensuke Kobayashi, Tokyo (JP); Tetsuo Watanabe, Utsunomiya-shi (JP); Katsushi Kato, Kawasaki-shi (JP)

(73) Assignee: CANON KABUSHIKI KAISHA, Tokyo (JP)

(21) Appl. No.: 14/133,332

(22) Filed: Dec. 18, 2013

(30) Foreign Application Priority Data
Dec. 21, 2012 (JP) 2012-279483

(51) Int. Cl. G01N 23/04

(52) U.S. Cl. CPC G01N 23/04
USPC 378/98; 378/91

(57) ABSTRACT

An X-ray imaging apparatus includes a plurality of X-ray detection cassettes, and an information processing section configured to communicate with the plurality of X-ray detection cassettes and to process information concerning the plurality of X-ray detection cassettes. Each of the plurality of X-ray detection cassettes transmits/receives, to/from the information processing section, first information that corresponds to an image control signal and image data of the X-ray detection cassette and second information that is different from the first information. In a case where a time at which the first information is transmitted/received and a time at which the second information is transmitted/received coincide with each other, the first information is preferentially transmitted/received.

### BACKGROUND OF THE INVENTION

1. Field of the Invention

The present invention relates to an X-ray imaging apparatus that acquires an X-ray image by detecting X-rays which have passed through a subject.

2. Description of the Related Art

X-ray imaging apparatuses that acquire an X-ray image of a subject by detecting an intensity distribution of X-rays which have passed through the subject are present.

In recent years, a scheme used in the X-ray imaging apparatuses has shifted from an old film-screen system to a system using a planar sensor in which pixels that are each constituted by a tiny photoelectric conversion element and a switching element are placed in a grid pattern.

The X-ray imaging apparatuses have a very large dynamic range compared with that of photosensitive films of the related art. Thus, the X-ray imaging apparatuses have an advantage that, even when the amount of x-ray exposure has changed, a stable X-ray image can be obtained, an advantage that an X-ray image can be obtained immediately because chemical processing does not need to be performed, and so forth.

Examples of X-ray imaging apparatuses include stationary detectors that are placed in a certain place such as a radiography room, and portable detectors (electronic cassettes) that can be freely moved.

Following wired cassettes which communicate with a control section via a cable and to which power is supplied via a cable from the outside, wireless cassettes that include an antenna for wireless communication and a battery for power supply have also emerged.

More particularly, a retrofit in which film-detectors are replaced with digital detectors without changing equipment for film cassettes of the related art has spread rapidly.

In addition, there have been situations in which a plurality of wireless cassettes are used or in which wireless cassettes are incorporated into stationary stand devices or tables and used.

In the above-described scenarios, an issue of how to notify an operator of whether an electronic cassette to be used can be used or which electronic cassette can be used occurs. As individual schemes for solving this issue, Patent Documents 1 to 4 have proposed the following.

In Patent Document 1 (Japanese Patent Laid-Open No. 2012-50620), it is proposed that, as a method for helping an operator select a wireless cassette that can be used for each of plural imaging conditions among a plurality of wireless cassettes, priorities be assigned, in decreasing order of the remaining capacity of a battery, to wireless cassettes that can be used for the imaging condition.

In Patent Document 2 (Japanese Patent Laid-Open No. 2006-95020), it is proposed that, as a method for providing a notification of the number of sheets which can be subjected to image by an electronic cassette at a time at which imaging starts, the number of sheets which can be subjected to imaging by an electronic cassette be calculated from the remaining capacity of a battery of the electronic cassette, and that a result of the calculation be displayed on a display section.

In Patent Document 3 (Japanese Patent No. 4838442), it is proposed that, as a method for providing a notification of position information indicating the position of an electronic cassette, an electronic cassette and a stand device in which the electronic cassette is loaded be determined as a combination, and that a result of determination be displayed on a display section.

In Patent Document 4 (Japanese Patent Laid-Open No. 2012-11057), it is proposed that, as a method for providing a notification of position and posture information indicating the position and posture of a wireless cassette, a wireless cassette, a stand device in which the wireless cassette is loaded, and the orientation of the wireless cassette in the stand device be determined as a set, and that a result of determination be displayed as a list on a display section.

However, with the above-proposed schemes, there is a possibility that a communication operation of an electronic cassette hinders an imaging operation of the electronic cassette. More particularly, in an environment in which a plurality of electronic cassettes are used in combination, there is a risk that a communication delay occurs in an electronic cassette, among the electronic cassettes, that is performing imaging due to communication performed by the other electronic cassettes other than the electronic cassette that is being used in imaging and an information processing section, or degradation in an image occurs due to noise caused by the communication.

### SUMMARY OF THE INVENTION

In accordance with embodiments of the present invention, a novel scheme for overcoming the shortcomings of the related art is disclosed. Notably, an X-ray imaging apparatus, in which, when communication is performed by a plurality of electronic cassettes and an information processing section, control is performed so that transmission of state information concerning the states of the electronic cassettes will not interfere with an imaging operation. The X-ray imaging apparatus includes a plurality of X-ray detection cassettes, and an information processing section. The information processing section is configured to communicate with the plurality of X-ray detection cassettes and to process information concerning the plurality of X-ray detection cassettes. Each of the plurality of X-ray detection cassettes transmits/receives to/from the information processing section first information that is based on an image control signal and image data of the X-ray detection cassette and second information that is different from the first information. In a case where a time at which the first information is transmitted/received and a time at which the second information is transmitted/received coincide with each other, the first information is preferentially transmitted/received. In the X-ray imaging apparatus including the plurality of X-ray detection cassettes, state information concerning the states of the plurality of X-ray detection cassettes can be managed without interfering with the imaging operation performed by a certain one X-ray detection cassette among the plurality of X-ray detection cassettes.

Further features of the present invention will become apparent from the following description of exemplary embodiments with reference to the attached drawings.

### BRIEF DESCRIPTION OF THE DRAWINGS

FIG. 1 is a schematic diagram of an X-ray imaging apparatus according to one or more embodiments described herein.

FIGS. 2A and 2B are schematic diagrams illustrating communication performed by one of X-ray detection cassettes and an information processing section.

FIG. 3 is a diagram illustrating communication timing of communication performed by the X-ray detection cassette and the information processing section, in accordance with a first embodiment.

FIG. 4 is a diagram illustrating communication timing of communication performed by one of the X-ray detection cassettes and the information processing section, in accordance with a second embodiment.

FIGS. 5A and 5B are schematic diagrams illustrating communication performed by each of the X-ray detection cassettes and the information processing section, in accordance with a third embodiment.

FIGS. 6A and 6B are schematic diagrams illustrating communication performed by each of the X-ray detection cassettes and the information processing section, in accordance with a fourth embodiment.

FIG. 7 is a schematic diagram of an X-ray imaging apparatus according to additional (fifth and sixth) embodiments.

FIGS. 8A and 8B are schematic diagrams illustrating communication performed by each of X-ray detection cassettes and the information processing section while an imaging operation is not being performed, and the display contents displayed on a display section in the fifth embodiment.

FIGS. 9A to 9C are schematic diagrams illustrating communication performed by each of the X-ray detection cassettes and the information processing section while the imaging operation is being performed, and the display contents displayed on the display section in the fifth embodiment.

FIGS. 10A and 10B are schematic diagrams illustrating communication performed by each of the X-ray detection cassettes and the information processing section while the imaging operation is not being performed, and the display contents displayed on the display section in the sixth embodiment.

FIGS. 11A to 11C are schematic diagrams illustrating communication performed by each of the X-ray detection cassettes and the information processing section while the imaging operation is being performed, and the display contents displayed on the display section in the sixth embodiment.

FIGS. 12A and 12B are schematic diagrams illustrating communication performed by each of the X-ray detection cassettes and the information processing section while the imaging operation is not being performed, and the display contents displayed on the display section in a seventh embodiment.

FIGS. 13A to 13C are schematic diagrams illustrating communication performed by each of the X-ray detection cassettes and the information processing section while the imaging operation is being performed, and the display contents displayed on the display section in the seventh embodiment.

FIGS. 14A to 14C are schematic diagrams illustrating communication performed by one of the X-ray detection cassettes and the information processing section, and the display contents displayed on a stand display section in an eighth embodiment.

FIGS. 15A to 15D are schematic diagrams illustrating communication performed by each of the X-ray detection cassettes and the information processing section while the imaging operation is not being performed, and the display contents displayed on the stand display section and the display section in a ninth embodiment.

FIGS. 16A to 16D are schematic diagrams illustrating communication performed by each of the X-ray detection cassettes and the information processing section while the imaging operation is being performed, and the display contents displayed on the stand display section and the display section in the ninth embodiment.

### DESCRIPTION OF THE EMBODIMENTS

Hereinafter, embodiments of the present invention will be described in detail with reference to the accompanying drawings. However, the number of electronic cassettes that are configured and the display contents displayed on various types of display sections in each of the embodiments are not limited to the number of electronic cassettes and the display contents in this specification and the drawings.

### First Embodiment

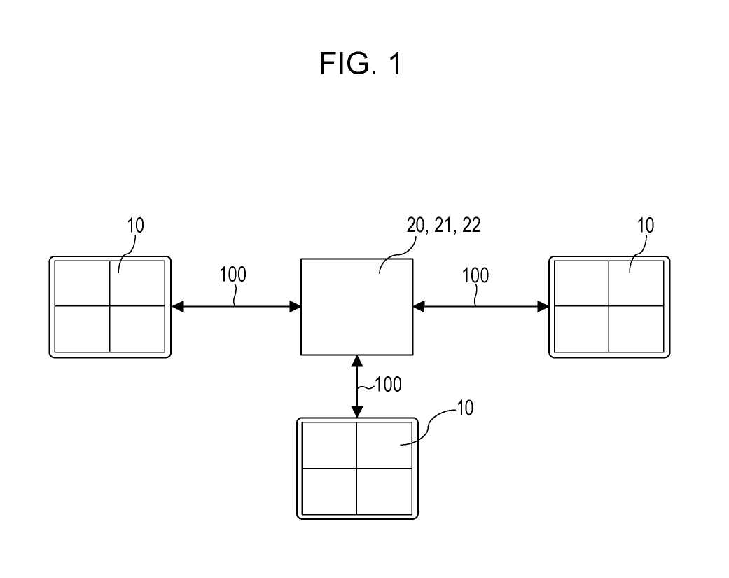

An X-ray imaging apparatus, which is related to radiography, according to each of first to fourth embodiments is schematically illustrated in FIG. 1. A plurality of electronic cassettes 10 are configured to establish a communication link (communication 100) with an information processing section 20. The number of electronic cassettes 10 is not limited to the number of electronic cassettes 10 illustrated in FIG. 1; the number can be more or less than those illustrated in FIG. 1. The information processing section 20 includes a control section 21 configured to control operations of each of the electronic cassettes 10. The control section 21, in the information processing section 20, may also control a display section 22 configured to display information concerning the electronic cassettes 10. Information that is transmitted/received using communication 100 may be classified as first information 101 based on an image control signal and image data of an X-ray detection cassette, or second information 102 whose contents are different from the contents of the first information 101. As used herein, a representative example of the “information processing section 20” may be X-ray modality configured to perform an imaging operation using a plurality of electronic cassettes, such as wired or wireless flat panel detectors (FPDs). In the context of mobile or fixed X-ray modalities, an example the “control section 21” may be an on-board computing system configured to receive and process information from one or more of the plurality of electronic cassettes. In other words, control section 21 may be implemented as one or more processors coupled to a memory that stores instructions executable to perform processing operations described more in detail below.

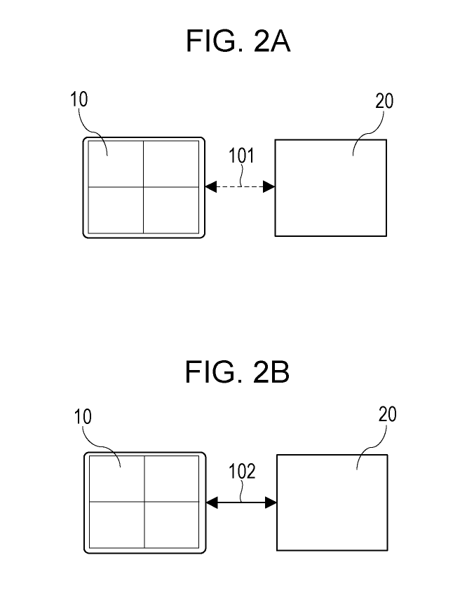

In FIGS. 2A and 2B, states of communication performed by a certain one of the electronic cassettes 10 and the information processing section 20 are selected and illustrated. While an imaging operation is not being performed by any one of the electronic cassettes 10, as illustrated in FIG. 2B, the electronic cassette 10 transmits/receives the second information 102 to/from the information processing section 20. However, for example, in the case where the electronic cassette 10 has started the imaging operation, at a time at which the electronic cassette 10 transmits/receives the first information 101 to/from the information processing section 20, as illustrated in FIG. 2A, the electronic cassette 10 stops transmission of the second information 102 so that the time at which the first information 101 is transmitted/received and a time at which the second information 102 is transmitted/received do not coincide with each other.

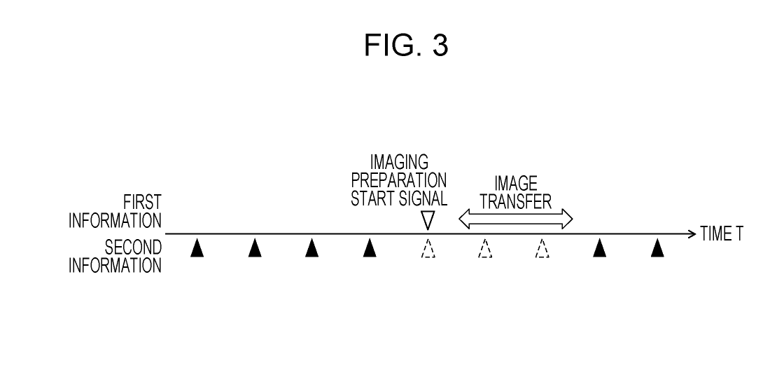

In FIG. 3, an example of communication timing of communication performed by the electronic cassette 10 and the information processing section 20 is illustrated, and the horizontal axis is a time axis. The electronic cassette 10 regularly transmits/receives the second information 102 to/from the information processing section 20 at certain time intervals. However, in the case of transmitting/receiving the first information 101 at a time at which the second information 102 should have been transmitted/received if the imaging operation was not being performed by the electronic cassette 10, the electronic cassette 10 or the information processing section 20 stops transmission of the second information 102, and performs transmission/reception of the first information 101. For example, in the case where a time at which the information processing section 20 transmits, to the electronic cassette 10, a signal (“imaging preparation start signal” in FIG. 3) for performing control so that the electronic cassette 10 will start preparation for imaging or a time at which the electronic cassette 10 receives the imaging preparation start signal from the information processing section 20 coincides with a time at which transmission/reception of the second information 102 is performed, the electronic cassette 10 or the information processing section 20 stops transmission/reception of the second information 102 at the time. Furthermore, for a time period (“image transfer” in FIG. 3) for which the electronic cassette 10 is transmitting X-ray image data, which has been acquired by the electronic cassette 10, to the information processing section 20, transmission/reception of the second information 102 is entirely interrupted. After the imaging operation performed by the electronic cassette 10 has finished, transmission/reception of the second information 102 is restarted at a predetermined timing.

In the present embodiment, without interfering with the imaging operation performed by the electronic cassette 10, the second information 102 can be continuously transmitted/received between the electronic cassette 10 and the information processing section 20. Furthermore, without disturbing the predetermined communication timing, transmission/reception of the second information 102 may be regularly performed. Thus, regarding a clock that is caused to operate in the electronic cassette 10 or the information processing section 20, the number of clock ticks can be reduced to the minimum number. The X-ray imaging apparatus includes the electronic cassettes 10, and the information processing section 20 configured to communicate with the electronic cassettes 10 and to process information concerning the electronic cassettes 10.

Each of the electronic cassettes 10 communicates with the information processing section 20 so that the first information 101 based on image data is transmitted/received in preference to the second information 102 different from the first information 101. In order words, each of the plurality of electronic cassettes 10 transmits/receives, to/from the information processing section 20, the first information 101, which is based on the image control signal and image data of the electronic cassette 10, and the second information 102 different from the first information 101. In the case where a time at which the first information 101 is transmitted/received and a time at which the second information 102 is transmitted/received coincide with each other, the electronic cassette 10 preferentially transmits/receives the first information 101. More specifically, as used herein, when a time at which the first information 101 is transmitted/received and a time at which the second information 102 is transmitted/received coincide with each other, the first information 101 is transmitted/received before the second information 102. However, preference of transmitting/receiving the first information 101 and the second information 102 may be reversed.

### Second Embodiment

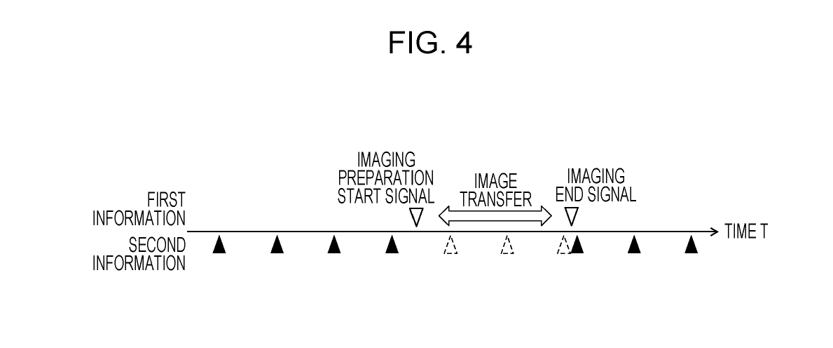

Communication between one of the electronic cassettes 10 and the information processing section 20 in the second embodiment is performed at communication timing illustrated in FIG. 4 so that information is transmitted/received in a preferential manner. In other words, while the electronic cassette 10 is not performing an imaging operation, the electronic cassette 10 regularly transmits/receives the second information 102 to/from the information processing section 20 at certain time intervals. However, when the information processing section 20 transmits a signal (for example, an imaging preparation start signal” in FIG. 4) for causing the electronic cassette 10 to start preparation for imaging or the electronic cassette 10 receives the imaging preparation start signal, while the imaging operation that starts from the next timing is continuing, the electronic cassette 10 or the information processing section 20 stops transmission/reception of the second information 102, and performs only transmission/reception of the first information 101. When the imaging operation performed by the electronic cassette 10 has been completed, the electronic cassette 10 transmits, to the information processing section 20, an imaging end signal indicating that the imaging operation has finished. When the information processing section 20 receives the imaging end signal, the information processing section 20 transmits, to the electronic cassette 10, a signal for restarting transmission/reception of the second information 102, whereby transmission/reception of the second information 102 is restarted. Furthermore, in the present embodiment, transmission/reception of the second information 102 is stopped as described above. However, a restriction such as prohibition of transmission/reception of the second information 102 may be imposed in advance. In this case, the information processing section 20 may transmit a communication prohibition signal.

In the present embodiment, immediately after transmission/reception of the first information 101 has finished, transmission/reception of the second information 102 can be restarted. Thus, a time lag between a time at which the second information 102 should have been updated and a time at which the second information 102 is updated in reality can be reduced to the minimum time lag. Furthermore, while transmission/reception of the second information 102 is being stopped, the clock may be stopped. The operation of the electronic cassette 10 that is performing the imaging operation can be simplified, compared with that in the first embodiment. Thus, an effect of saving electric power can also be obtained.

### Third Embodiment

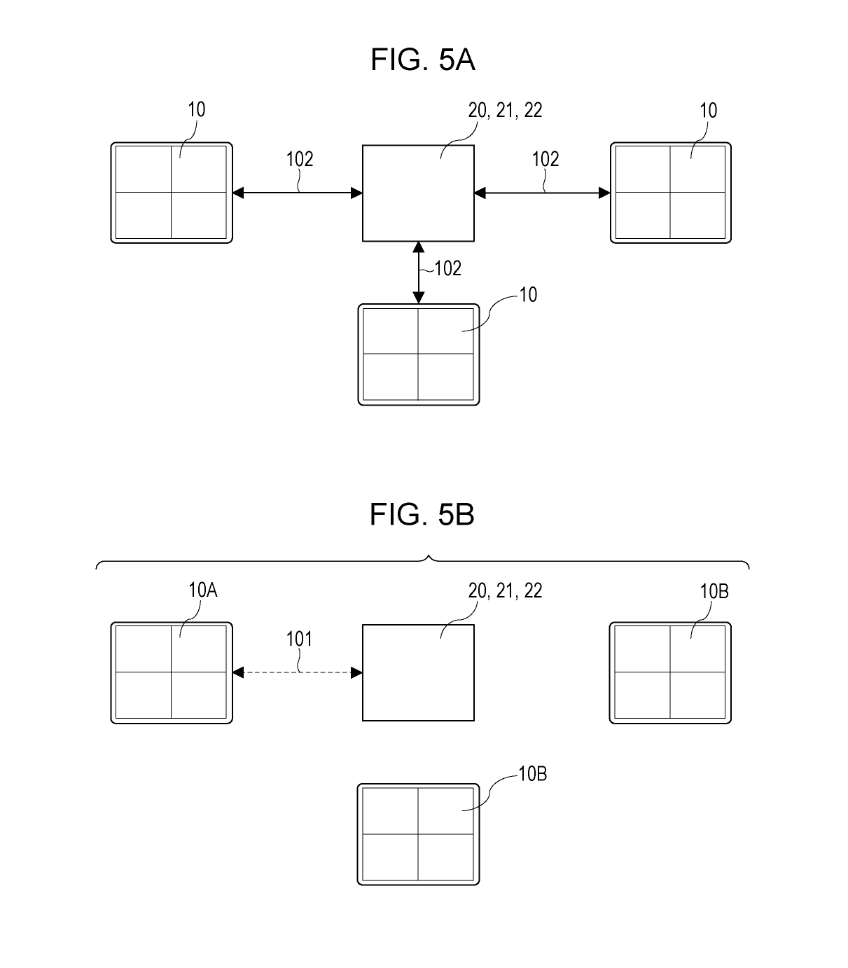

States of communication performed in the X-ray imaging apparatus according to the third embodiment are illustrated in FIGS. 5A and 5B. While imaging is not being performed by any one of the electronic cassettes 10, as illustrated in FIG. 5A, the electronic cassettes 10 transmit/receive the second information 102 to/from the information processing section 20. However, in the case of performing imaging with a certain one of the electronic cassettes 10, the information processing section 20 notifies all of the electronic cassettes 10 that the imaging operation is to be performed by a certain one of the electronic cassettes 10. Then, all of the electronic cassettes 10 stop transmission/reception of the second information 102. Thus, as illustrated in FIG. 5B, only an electronic cassette 10A that is the certain electronic cassette 10 which performs the imaging operation transmits/receives the first information 101 to/from the information processing section 20. As a result, while imaging is being performed by the electronic cassette 10A that is the certain electronic cassette, it is only necessary for the information processing section 20 to communicate with the electronic cassette 10A that is performing imaging. The amount of information that should be processed can be reduced to the minimum amount needed. Thus, the imaging operation can be efficiently and accurately performed.

### Fourth Embodiment

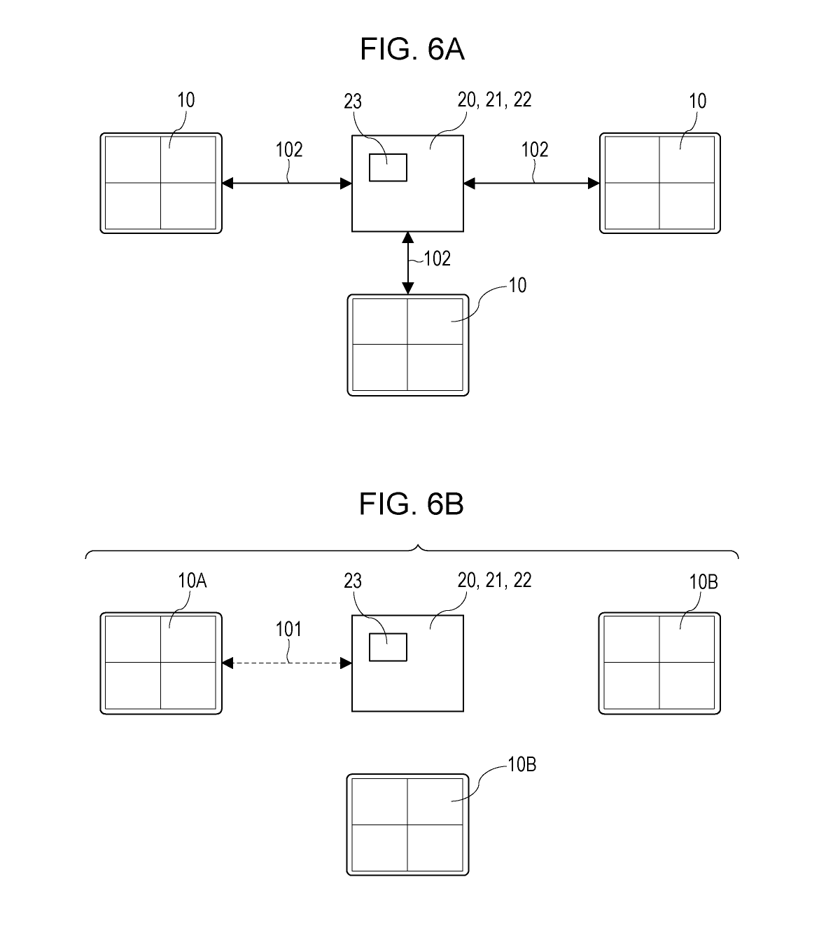

States of communication performed in the X-ray imaging apparatus according to the fourth embodiment are illustrated in FIGS. 6A and 6B. The difference between FIGS. 5A and 5B and FIGS. 6A and 6B is that the information processing section 20 includes a storage unit 23. In other words, while imaging is not being performed by any one of the electronic cassettes 10, as illustrated in FIG. 6A, the electronic cassettes 10 transmit/receive the second information 102 to/from the information processing section 20. In the case of performing imaging with a certain one of the electronic cassettes 10, the information processing section 20 transmits, to the certain electronic cassette 10A, a signal for starting the imaging operation. In addition, the information processing section 20 acquires the second information 102 of all of the electronic cassettes 10, and stores the second information 102 in the storage unit 23. After that, the information processing section 20 controls electronic cassettes 10B that are the other electronic cassettes 10 which are not to perform imaging so that the electronic cassettes 10B will not transmit/receive the second information 102. An effect unique to the present embodiment with respect to the effect obtained in the third embodiment is that, during imaging performed by the certain electronic cassette 10A, even while information concerning the electronic cassettes 10B, which are not performing imaging, is not being updated at all, regarding state information indicating the states of the electronic cassettes 10B, which are not performing imaging, the state information that is in a state immediately before imaging starts can be held. The state information includes, for each of the electronic cassettes 10, position information indicating the position of the electronic cassette 10, a driving state of the electronic cassette 10, a state of a battery of the electronic cassette 10, a communication state of the electronic cassette 10, and so forth.

### Fifth Embodiment

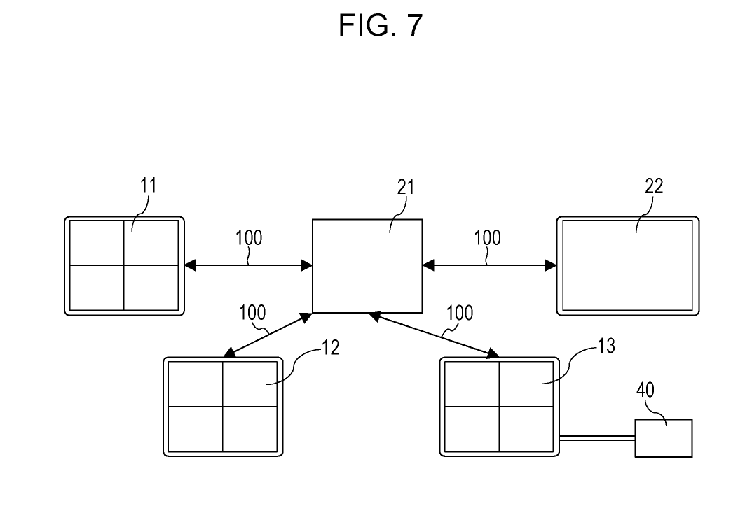

FIG. 7 is a schematic diagram of an X-ray imaging apparatus according to each of fifth and sixth embodiments. The X-ray imaging apparatus includes three electronic cassettes 11 to 13 and the control section 21. The electronic cassettes 11 to 13 and the control section 21 can perform communication 100 with each other. A display section 22 is connected to the control section 21 so as to be capable of perform communication 100. Information concerning the electronic cassettes 11 to 13 is displayed on the display section 22.

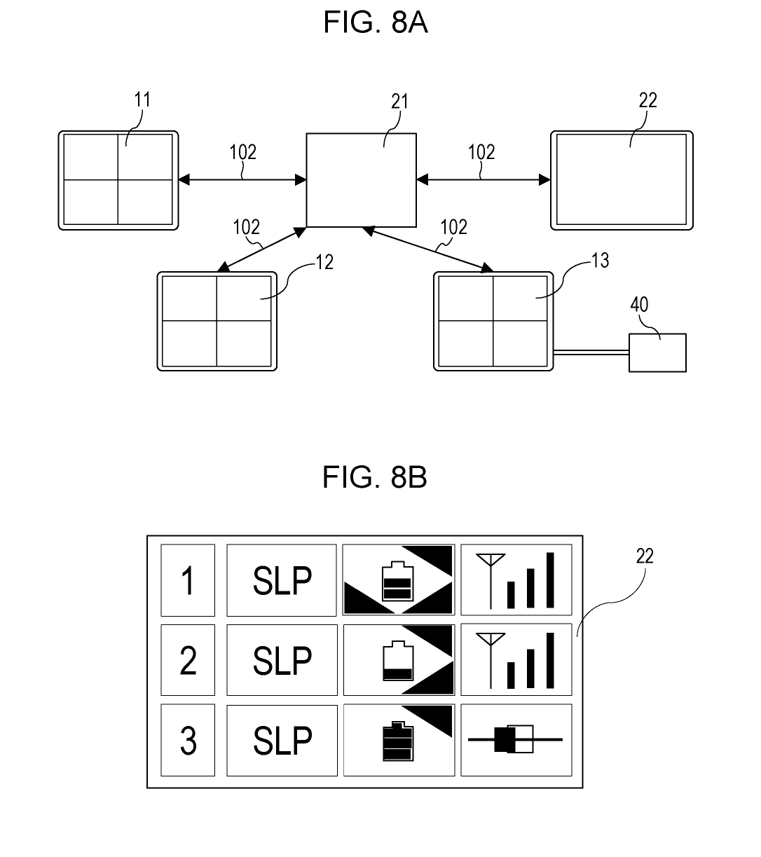

While imaging is not being performed by any one of the electronic cassettes 11 to 13, as illustrated in FIG. 8A, the electronic cassettes 11 to 13 transmit/receive the second information 102 to/from the control section 21. The second information 102 that has been received by the control section 21 is transmitted to the display section 22, and displayed on the display section 22. An example of display is illustrated in FIG. 8B. Here, ID numbers are assigned to the three electronic cassettes 11 to 13 that can communicate with the control section 21, and a list of the ID numbers is displayed. The display contents are an “ID number”, a “driving state”, a “remaining capacity of a battery of each of the electronic cassettes and the number of times the battery has been charged”, and a “communication state” in this order from the left in FIG. 8B. As the “driving state” of each of the electronic cassettes 11 to 13, a “SLEEP” state in which the electronic cassette has not started preparation for imaging although the power of the electronic cassette is turned on is displayed. As the “communication state”, a field intensity is displayed in a cell for each of the electronic cassette having an ID number of “1” and the electronic cassette having an ID number of “2” that are electronic cassettes connected to the control section 21 in a wireless manner, and an icon representing a wired connection is displayed in a cell for the electronic cassette having an ID number of “3” that is an electronic cassette connected to the control section 21 via a cable in a wired manner. Here, a configuration may be used, in which power is supplied to the electronic cassette 13 from an external power source 40 via a cable, and in which the battery of the electronic cassette 13 is charged by the supplied power. In this case, unique display, such as display in which the icon in the cell of the “remaining capacity of the battery and the number of times the battery has been charged” is caused to blink or in which the icon is changed to another icon, can be performed so as to indicate “charging”. Note that the reason why the number of times the built-in battery has been changed is displayed is that a characteristic that the capability of being charged or discharged decreases with increasing number of times the battery has been charged is taken into consideration. The control section 21 or the display section 22 may have a function of prompting a user to replace the battery with another battery in the case where the number of times the battery has been charged has approached a predetermined number of times the battery has been charged. Note that it is assumed that the above-mentioned information indicating the state of the battery includes information indicating the charging state of the battery.

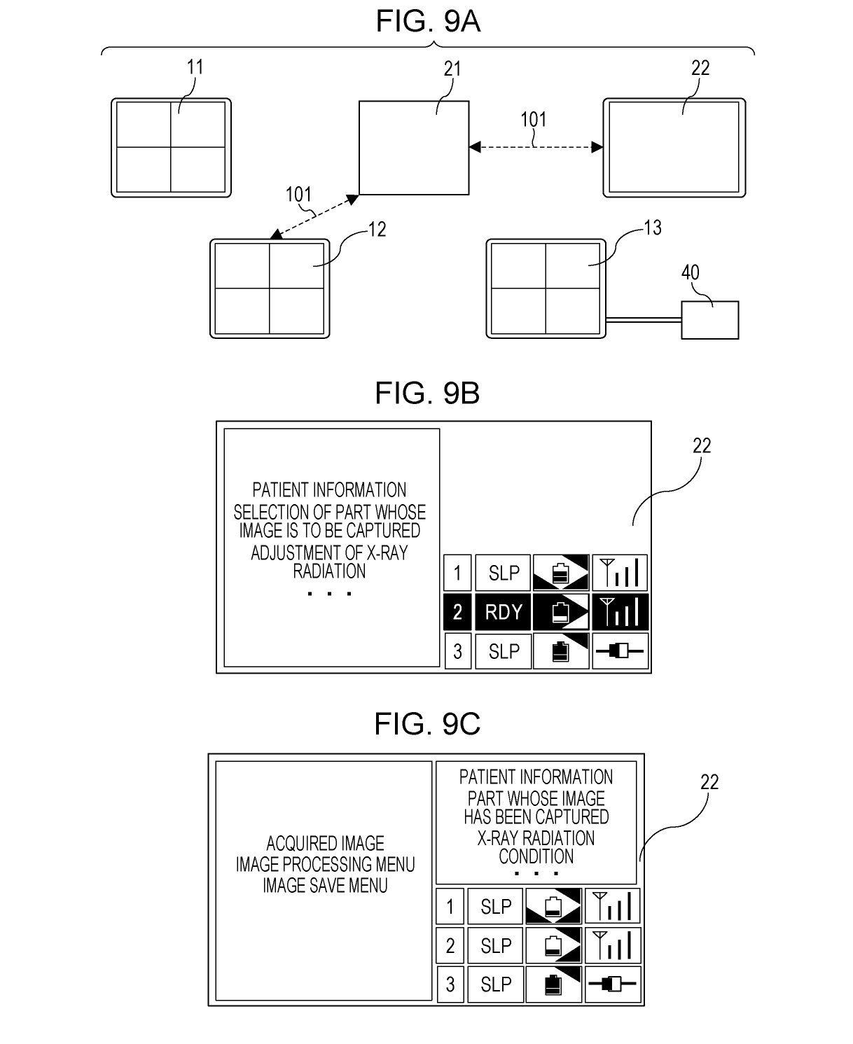

In the case of performing imaging with the electronic cassette 12, first, an instruction to select the electronic cassette 12 is input from an input device that is connected to the display section 22 or the control section 21. Then, the control section 21 transmits, to the electronic cassette 12, a signal for starting the imaging operation. In addition, as illustrated in FIG. 9A, the control section 21 controls the electronic cassettes 11 and 13, which are not to perform the imaging operation, so that the electronic cassettes 11 and 13 will not transmit/receive the second information 102. In this case, display is performed on the display section 22 as illustrated in FIG. 9B. In other words, a region in which state information indicating the states of the electronic cassettes 11 to 13 is displayed is smaller than a region in which an operation menu necessary for the imaging operation is displayed. It is understandable that the electronic cassette 12 having an ID number of “2” is in a “READY” state in which preparation for imaging has been completed. At this point in time, the state information indicating the states of all of the electronic cassettes 11 to 13 that are under control has not been updated to the latest information because communication control is performed by the control section 21. However, the display section 22 holds the display contents before the above-described communication control is performed.

When an X-ray image has been acquired by the electronic cassette 12 and transmitted to the control section 21, display is performed on the display section 22 as illustrated in FIG. 9C. In other words, the acquired image and an operation menu that is necessary to check, process, and save the acquired image occupy the maximum region in a display screen. The state information indicating the states of the electronic cassettes 11 to 13 is displayed in a small region as with the state information illustrated in FIG. 9B. At this point in time, the control section 21 has received, from the electronic cassette 12, a notification indicating that the imaging operation has been completed, and restarts transmission/reception of the second information 102 to/from all of the electronic cassettes 11 to 13. Thus, the display contents have been updated, for example, resulting in the display contents indicating that the remaining capacity of the battery of the electronic cassette 11 has decreased.

Here, the control section 21 has a function of determining whether the remaining capacity of the battery of each of the electronic cassettes 11 to 13 that are under control is insufficient for a capacity of the battery necessary for imaging that is to be performed once. When it is determined that the remaining capacity of the battery of one of the electronic cassettes 11 to 13 that is a remaining capacity which the electronic cassette has in reality is insufficient with respect to a reference capacity, the control section 21 can prompt, using display and sounds, the user to replace the battery with another battery or charge the battery. For example, in the above-described case where preparation for imaging starts, the electronic cassette 12 receives the signal for starting the imaging operation, and, in response to that, the electronic cassette 12 transmits, to the control section 21, the second information 102 of the electronic cassette 12. The control section 21 determines, on the basis of the received information, whether the remaining capacity of the battery of the electronic cassette 12 can withstand imaging. If it is determined that the remaining capacity of the battery of the electronic cassette 12 is insufficient, the control section 21 stops imaging with the electronic cassette 12. In this manner, a situation that leads to not only a loss of an image but also unnecessary radiation of a subject with X-rays because the electronic cassette 12 falls into a state in which the power of the electronic cassette 12 is turned off after radiation with X-rays is given can be prevented in advance.

In the present embodiment, the user can grasp, from the control section 21, the state information indicating the states of all of the electronic cassettes 11 to 13 that are under control at one time. Furthermore, even while any one of the electronic cassettes 11 to 13 is performing the imaging operation, the user can grasp comparatively new information that has been obtained before the imaging operation starts. Moreover, the user can be made aware of the remaining capacities of the batteries of the electronic cassettes 11 to 13, and based on this information, the user may perform maintenance of the electronic cassettes which are under control and must withstand the demands for imaging which is to be performed once.

### Sixth Embodiment

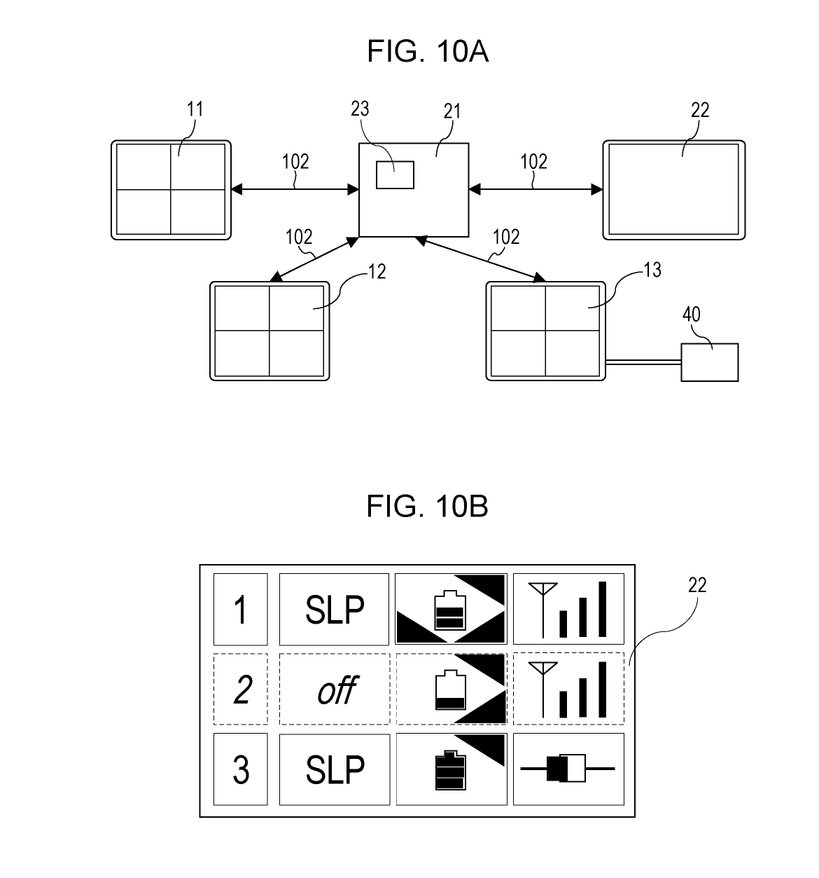

States of communication performed in the X-ray imaging apparatus according to the sixth embodiment are illustrated in FIGS. 10A and 10B. The difference between FIGS. 8A and 8B and FIGS. 10A and 10B is that the control section 21 includes the storage unit 23. The control section 21 stores, in the storage unit 23, the state information indicating the states of the individual electronic cassettes 11 to 13 that have been acquired from all of the electronic cassettes 11 to 13 which are under control. Only information concerning an electronic cassette, among the electronic cassettes 11 to 13, that can communicate with the control section 21 out of the stored information is updated every time the second information 102 is transmitted/received. However, regarding information concerning an electronic cassette whose power is turned off, information other than the “driving state” (“off” in FIG. 10B) is held. In contrast, regarding information concerning an electronic cassette that has become unable to communicate with the control section 21 due to a reason other than turning off of the power of the electronic cassette, only the “remaining capacity of the battery” is held.

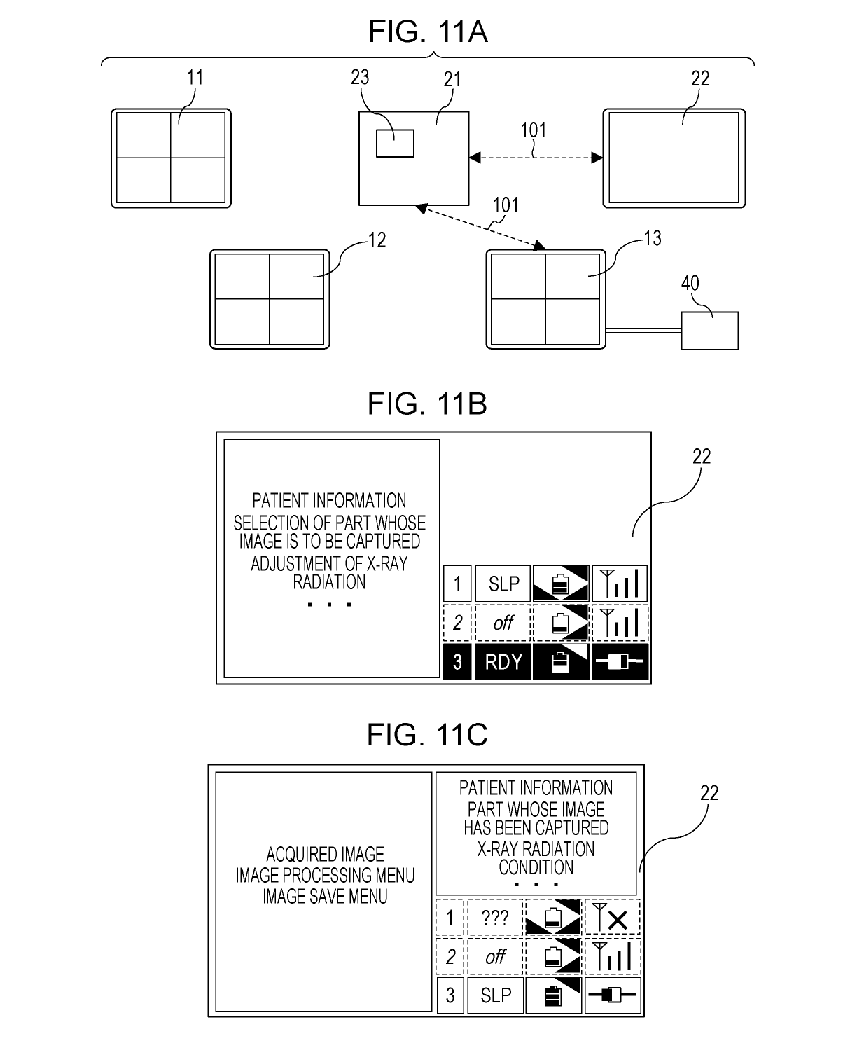

An operation of the X-ray imaging apparatus according to the present embodiment under the above-mentioned assumption is described below. While imaging is not being performed by any one of the electronic cassettes 11 to 13, as illustrated in FIG. 10A, the electronic cassettes 11 to 13 transmit/receive the second information 102 to/from the control section 21. In this case, display is performed on the display section 22 as illustrated in FIG. 10B. Only for the electronic cassette 12, the driving state indicating that the power thereof is turned off is displayed. Regarding the “remaining capacity of the battery” and the “communication state”, the contents that have been stored in the storage unit 23 before driving of the electronic cassette 12 is stopped. In the case of performing imaging with the electronic cassette 13, the control section 21 transmits a signal for starting the imaging operation to the electronic cassette 13. In addition, the control section 21 acquires the second information 102 of all of the electronic cassettes 11 to 13, and stores the second information 102 in the storage unit 23. In this case, the control section 21 determines whether the remaining capacity of the battery of the electronic cassette 13 that is to perform imaging can withstand imaging that is ordered. In case the remaining capacity of the battery is insufficient, the control section 21 stops imaging with the electronic cassette 13. The control section 21 inquires, of the user, whether the electronic cassette to be used in imaging may be changed to the electronic cassette 11 whose power is turned on at this point in time. When it is determined that the remaining capacity of the battery of the electronic cassette 13 can withstand imaging, as illustrated in FIG. 11A, the control section 21 controls the electronic cassettes 11 and 12, which are not to perform imaging, so that the electronic cassettes 11 and 12 will not transmit/receive the second information 102. In this case, display is performed on the display section 22 as illustrated in FIG. 11B. In other words, a region in which the state information indicating the states of the electronic cassettes 11 to 13 is displayed is smaller than a region in which the operation menu necessary for the imaging operation is displayed. It is understandable that the electronic cassette 13 is in the “READY” state in which preparation for imaging has been completed. At this point in time, the state information indicating the states of all of the electronic cassettes 11 to 13 that are under control has not been updated to the latest information because communication control is performed by the control section 21. However, the display section 22 displays the display contents that are stored in the storage unit 23.

When an X-ray image has been acquired by the electronic cassette 13 and transmitted to the control section 21, display is performed on the display section 22 as illustrated in FIG. 11C. In other words, the acquired image and the operation menu that is necessary to check, process, and save the acquired image occupy the maximum region in the display screen. The state information indicating the states of the electronic cassettes 11 to 13 is displayed in a small region as with the state information illustrated in FIG. 11B. At this point in time, the control section 21 has received, from the electronic cassette 13, a notification indicating that the imaging operation has been completed, and restarts transmission/reception of the second information 102 to/from all of the electronic cassettes 11 to 13. The display contents have been updated, for example, resulting in the display contents indicating that the electronic cassette 11 has become unable to communicate with the control section 21 without turning off the power of the electronic cassette 11.

Here, the control section 21 has a function of determining whether the remaining capacity of the battery of each of the electronic cassettes 11 to 13 that are under control is insufficient for a capacity of the battery necessary for imaging that is to be performed a predetermined number of times. When it is determined that the remaining capacity of the battery of one of the electronic cassettes 11 to 13 that is a remaining capacity which the electronic cassette has in reality is insufficient with respect to a reference capacity, the control section 21 changes the frequency of acquisition of the state information indicating the state of the electronic cassette with respect to the frequency of acquisition of the state information indicating the states of the other electronic cassettes. The frequency of acquisition of the state information can be increased or reduced, and whether to increase or decrease the frequency of acquisition of the state information is selected by the user. In the case where the frequency of acquisition of the state information is increased, the remaining capacity of the battery of the electronic cassette can be more closely monitored. In contrast, in the case where the frequency of acquisition of the state information is reduced, the number of times the electronic cassette performs communication can be reduced, and, consequently, consumption of power by communication can be reduced.

There are three effects unique to the present embodiment with respect to the effect obtained in the fifth embodiment. The first effect is that, regarding the state information indicating the state of an electronic cassette, among the electronic cassettes 11 to 13, which is unable to communicate with the control section 21, such as the driving state indicating that the power of the electronic cassette is turned off, the state information that is in the latest state before communication is interrupted can be grasped. The second effect is that, during imaging performed by a certain electronic cassette, among the electronic cassettes 11 to 13, even while information concerning the electronic cassettes which are not performing imaging is not being updated at all, regarding the state information indicating the states of the electronic cassettes that are not performing imaging, the state information that is in a state immediately before imaging starts can be held. The third effect is that the user can be more carefully navigated so as to perform maintenance so that the remaining capacities of the batteries of the electronic cassettes 11 to 13 which are under control can withstand being used.

### Seventh Embodiment

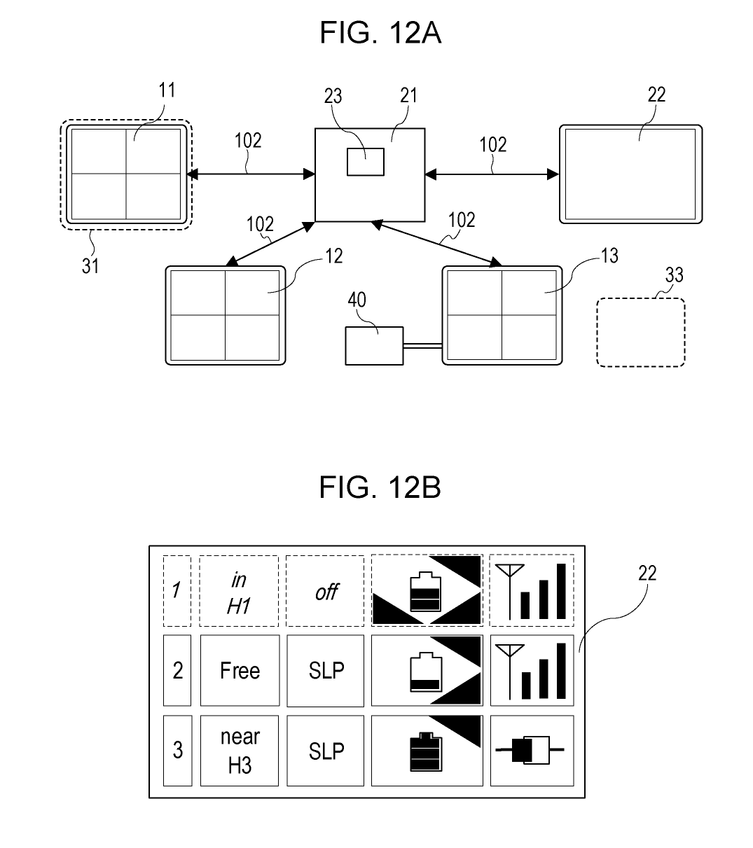

An X-ray imaging apparatus according to a seventh embodiment is configured as illustrated in FIG. 12A. The electronic cassette 11 having an ID number of “1” is housed in an upright position stand 31 so as to be detachably attached to the upright position stand 31. The electronic cassette 13 having an ID number of “3” is placed within a predetermined distance from a universal stand 33 (hereinafter, this relative positional relationship is referred to as “in the vicinity of”). The electronic cassette 12 having an ID number of “2” is not in the vicinity of any one of stand devices 30 that include the upright position stand 31 and the universal stand 33. Each of the electronic cassettes 11 to 13 has a unit configured to detect a stand device 30 that exists in the vicinity of the electronic cassette, and configured to, when a plurality of stand devices 30 have been detected, calculate distances between the electronic cassette and the stand devices 30 and to determine the closest stand device 30. When imaging is not being performed, all of the electronic cassettes 11 to 13 transmit/receive, to/from the control section 21, the second information 102 that is combination information indicating a combination of some pieces of information including the above-mentioned current position. In this case, the above-mentioned placement is reflected in the display contents that are the “ID number”, the “current position”, the “driving state”, the “remaining capacity of the battery of each of the electronic cassettes and the number of times the battery has been charged”, and the “communication state” in this order from the left, and the display contents are displayed on the display section 22 as illustrated in FIG. 12B. Note that information indicating that the electronic cassette 11 is housed in an upright position stand having an ID number of H1 is information that is acquired and stored in the storage unit 23 by the control section 21 when the power of the electronic cassette 11 is turned off after the electronic cassette 11 has been housed in the upright position stand 31.

The control section 21 has a unit configured to determine, in accordance with an imaging order, an electronic cassette, among the electronic cassettes 11 to 13, that is to be used in imaging. The control section 21 may determine that a plurality of electronic cassettes are to be used for a plurality of imaging orders. Hereinafter, operations of the control section 21 and the display section 22 will be described using, as an example, a case where the control section 21 determines that imaging is to be performed for the first time by the electronic cassette 12, and that imaging is to be performed for the second time by the electronic cassette 11.

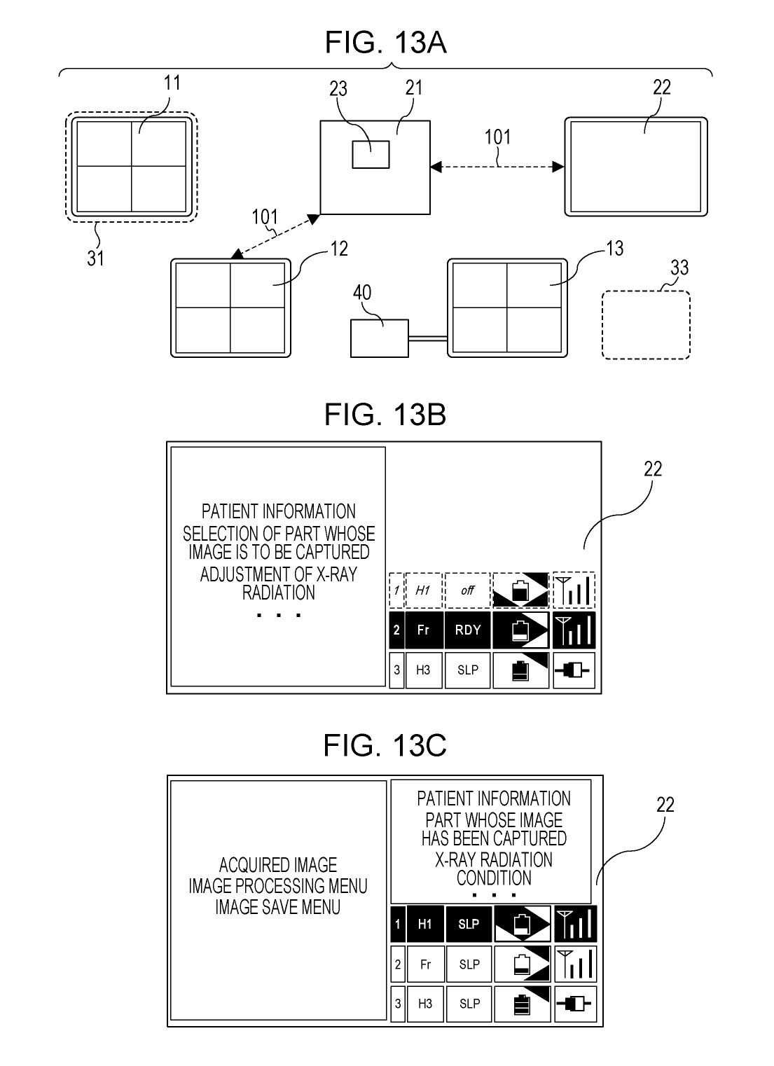

First, the control section 21 transmits, to the electronic cassette 12, a signal for starting the imaging operation. In addition, the electronic cassette 12 acquires the second information 102 of all of the electronic cassettes 11 to 13, and stores the second information 102 in the storage unit 23. Then, as illustrated in FIG. 13A, the control section 21 controls the electronic cassettes 11 and 13, which are not to perform imaging, so that the electronic cassettes 11 and 13 will not transmit/receive the second information 102. In this case, display is performed on the display section 22 as illustrated in FIG. 13B. In other words, a region in which the state information indicating the states of the electronic cassettes 11 to 13 is displayed is smaller than a region in which the operation menu necessary for the imaging operation is displayed, and, consequently, the display contents of the state information are simplified. It is understandable that the electronic cassette 13 is in the “READY” state in which preparation for imaging has been completed. At this point in time, the state information indicating the states of all of the electronic cassettes 11 to 13 that are under control has not been updated to the latest information because communication control is performed by the control section 21. However, the display section 22 displays the display contents that are stored in the storage unit 23.

When an X-ray image has been acquired by the electronic cassette 12 and transmitted to the control section 21, display is performed on the display section 22 as illustrated in FIG. 13C. In other words, the acquired image and the operation menu that is necessary to check, process, and save the acquired image occupy the maximum region in the display screen. The state information indicating the states of the electronic cassettes 11 to 13 is displayed in a small region as with the state information illustrated in FIG. 13B. When the control section 21 has received, from the electronic cassette 13, a notification indicating that the imaging operation has been completed, the control section 21 restarts transmission/reception of the second information 102 to/from all of the electronic cassettes 11 to 13. However, the control section 21 preferentially transmits/receives the second information 102 to/from the electronic cassette 11 that is to be used in imaging for the next time. In response to this, the display contents in the row for the electronic cassette 11 are preferentially updated, and also updated so that the visibility of the row for the electronic cassette 11 is higher than that of the rows for the other electronic cassettes.

There are two effects unique to the present embodiment. The first effect is that, regarding the current position of each of the electronic cassettes 11 to 13, the current position in the latest state can be grasped. The unit configured to detect a position uses a scheme in which a detection target, such as a mark, that is provided on each of the stand devices 30 is detected by a detector of each of the electronic cassettes 11 to 13. Thus, the device configuration can be simplified. Furthermore, in the case where one of the electronic cassettes 11 to 13 exists in the vicinity of one of the stand devices 30, the stand device 30 is displayed as a symbol. Thus, the current position of the electronic cassette is clear. The second effect is that, in the case where imaging orders have been given continuously, the control section 21 can preferentially notify the user of the state information indicating the state of an electronic cassette, among the electronic cassettes 11 to 13, that is determined to be an electronic cassette to be used in imaging for the next time. By promptly grasping the state information indicating the state of an electronic cassette that is determined to be an electronic cassette to be used for the next time, the imaging orders that have been given continuously can be processed smoothly.

### Eighth Embodiment

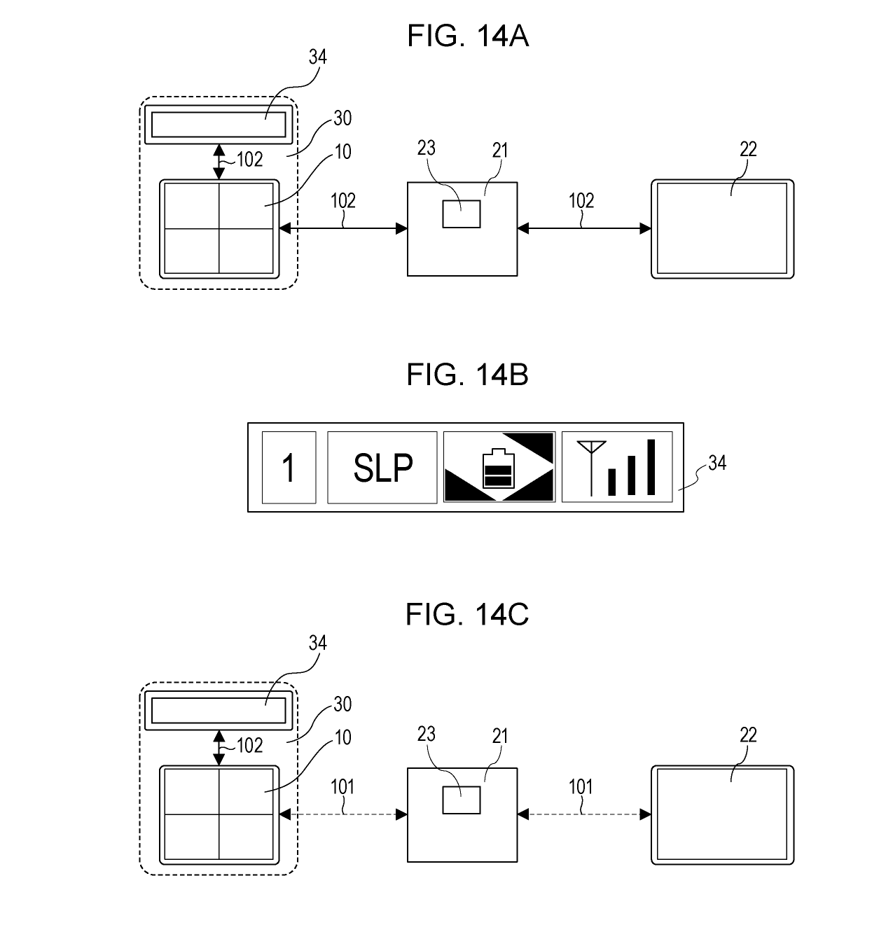

A schematic diagram of an X-ray imaging apparatus, in which the number of electronic cassettes 10 is one, according to an eighth embodiment is FIG. 14A. The electronic cassette 10 that is connected to the control section 21 so as to be capable of communicating with the control section 21 is housed in a stand device 30. When imaging is not being performed, the electronic cassette 10 transmits/receives the second information 102 to/from the control section 21. The display section 22 is also connected to the control section 21 so as to be capable of communicating with the control section 21, and displays the second information 102 that has been transmitted/received by the control section 21 to/from the electronic cassette 10. Meanwhile, the stand device 30 includes a stand display section 34 configured to display the ID number of the electronic cassette 10 housed in the stand device 30 together with the second information 102 that has been transmitted/received to/from the electronic cassette 10. The stand display section 34 includes a detection unit (e.g., optical or magnetic sensor) configured to detect that an electronic cassette is housed therein. Only when an electronic cassette is housed within the stand device 30, the stand display section 34 performs communication with another device and performs display. Similarly, the electronic cassette 10 includes a detection unit configured to detect that the electronic cassette 10 is housed in the stand device 30 and to obtain an ID number of the stand device 30 in which the electronic cassette 10 is housed. In this manner, the electronic cassette 10 determines the stand display section 34 that is to transmit/receive the second information 102. The electronic cassette 10 adds the ID number of the electronic cassette 10 to the second information 102 so that the second information 102 will include the ID number of the electronic cassette 10, and transmits/receives the second information 102 to the control section 21 and the stand display section 34. The display contents displayed on the stand display section 34 are the “ID number of a housed electronic cassette”, the “driving state of the electronic cassette”, the “remaining capacity of the battery of the electronic cassette and the number of times the battery has been charged”, and the “communication state of the electronic cassette” in this order from the left as illustrated as an example in FIG. 14B. There is an advantage that, even in a situation in which the electronic cassette 10 is hidden in the stand device 30, the ID number and state of the electronic cassette 10 which is housed inside the stand device 30 can be easily grasped by observing the stand display section 34.

In the case where the imaging operation is to be started by the electronic cassette 10, the control section 21 collects the second information 102 of the electronic cassette 10, and stores the second information 102 in the storage unit 23. After that, the control section 21 controls the electronic cassette 10 so that the electronic cassette 10 will stop transmission/reception of the second information 102 to/from the control section 21. During a time period from when this control is performed to when transmission/reception of the second information 102 is restarted, the second information 102 stored in the storage unit 23 is displayed together with the first information 101 on the display section 22. Meanwhile, even during this time period, as illustrated in FIG. 14C, the electronic cassette 10 continuously transmits/receives the second information 102 to/from the stand display section 34. Accordingly, regarding the display contents displayed on the stand display section 34, the display contents in the latest state are continuously shown. This leads to an advantage that, during preparation for an imaging operation, the user who performs a task mainly in the vicinity of the stand device 30 can readily grasp the state of the electronic cassette 10 that is hidden in the stand device 30. Furthermore, in the case where the stand display section 34 is configured as another unit that can be added on the stand device 30, particular alteration to the stand device 30 is unnecessary. Thus, the stand display section 34 can be easily installed in old equipment such as a stand device for a film cassette.

### Ninth Embodiment

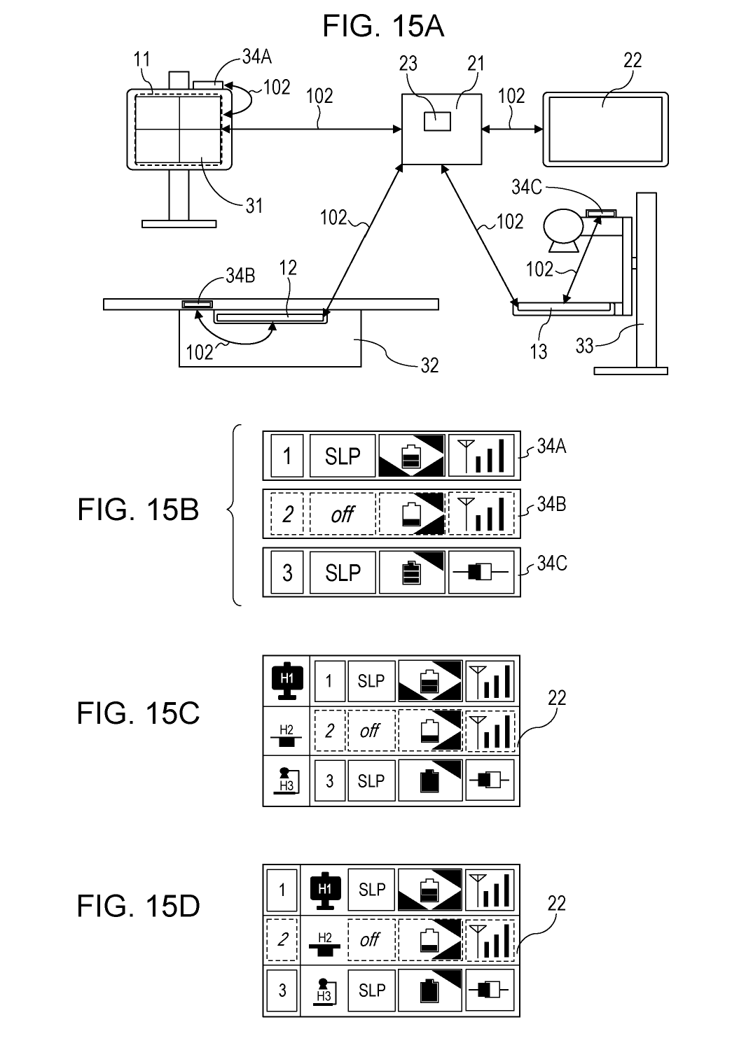

A schematic diagram of an X-ray imaging apparatus according to a present embodiment is FIG. 15A. Each of the three electronic cassettes 11 to 13 is housed in a corresponding one of stand devices 31 to 33, and is connected to the control section 21 so as to perform communication 100 with the control section 21. In other words, the electronic cassette 11 having an ID number of “1” is housed in the upright position stand 31, the electronic cassette 12 having an ID number of “2” is housed in a recumbent position table 32, and the electronic cassette 13 having an ID number of “3” is housed in the universal stand 33. Each of stand display sections 34A to 34C is provided in a corresponding one of the stand devices 31 to 33. The second information 102 that has been transmitted/received to/from each of the housed electronic cassettes 11 to 13 is displayed on a corresponding one of the stand display section 34A to 34C, as illustrated in FIG. 15B. The ID number of each of the housed electronic cassettes 11 to 13 is included in the second information 102. The “ID number of a housed electronic cassette”, the “driving state of the electronic cassette”, the “remaining capacity of the battery of the electronic cassette and the number of times the battery has been charged”, and the “communication state of the electronic cassette” are displayed in this order from the left.

In contrast, a list of the second information 102 of all of the electronic cassettes 11 to 13 that are under control is displayed on the display section 22 connected to the control section 21, as illustrated in FIG. 15C. In other words, the “type and ID number of a stand device”, the “ID number of a housed electronic cassette”, the “driving state of the electronic cassette”, the “remaining capacity of the battery of the electronic cassette and the number of times the battery has been charged”, and the “communication state of the electronic cassette” are displayed in this order from the left. Using this display method, for a desired stand device, a state in which an electronic cassette is housed in the stand device can be easily grasped.

Here, the method for displaying the second information 102 on the display section 22 can be changed as illustrated in FIG. 15D. In other words, the “ID number of an electronic cassette” is displayed at the left side of the “type and ID number of a stand device”. ID numbers in the column of the “ID number of an electronic cassette” can be sorted in an order desired by the user and can be displayed. For a desired electronic cassette, a stand device in which the electronic cassette is housed and a state in which the electronic cassette is housed in the stand device can be easily grasped.

The control section 21 has a unit configured to determine, in accordance with an imaging order, a stand device, among the stand devices 31 to 33, that is to be used in imaging. The control section 21 may determine that a plurality of stand devices are to be used for a plurality of imaging orders. However, the control section 21 communicates with only the electronic cassettes 11 to 13. Thus, in the case of imaging, the control section 21 transmits/receives the first information 101 concerning the imaging operation to/from an electronic cassette, among the electronic cassettes 11 to 13, that is housed in a desired stand device. Hereinafter, operations of the control section 21 and the display section 22 will be described using, as an example, a case where the control section 21 determines that imaging is to be performed for the first time using the universal stand 33 having an ID number of “H3”, and that imaging is to be performed for the second time using the upright position stand 31 having an ID number of “H1”.

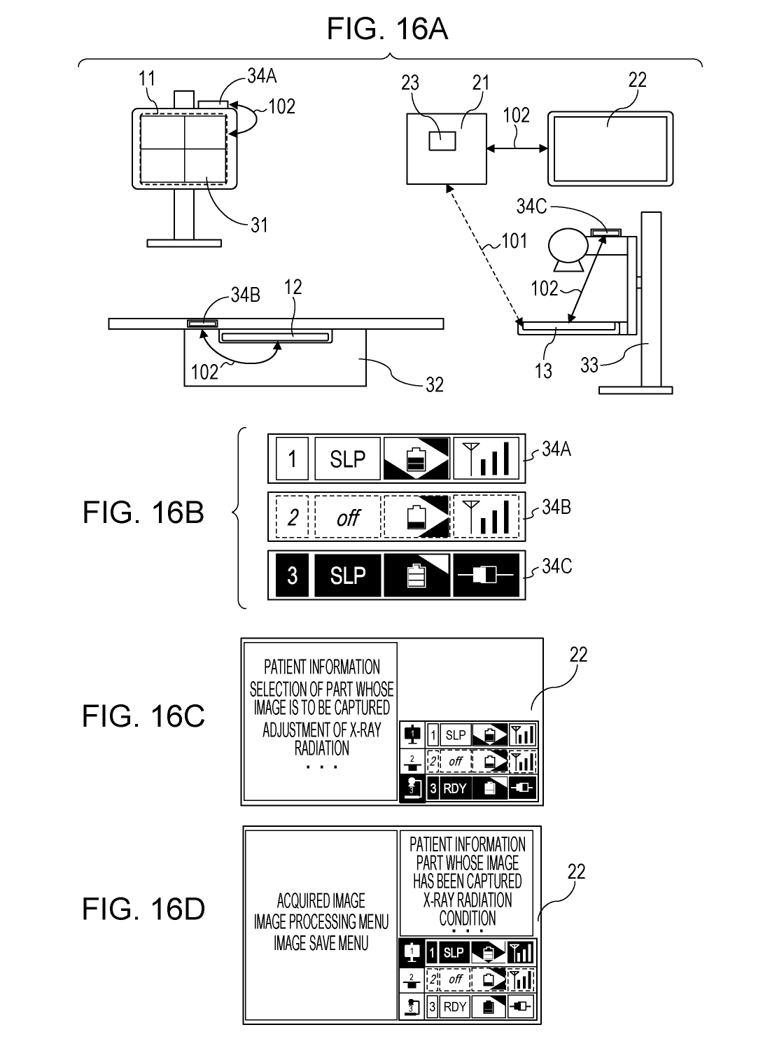

In the case of performing imaging, an instruction to select the electronic cassette 13 or the universal stand 33 is input from any one of input devices connected to the display section 22, the stand display sections 34A to 34C, and the control section 21. Then, the control section 21 collects the second information 102 of all of the electronic cassettes 11 to 13, and stores the second information 102 in the storage unit 23. After that, the control section 21 controls all of the electronic cassettes 11 to 13 so that the electronic cassettes 11 to 13 will stop transmission/reception of the second information 102 to/from the control section 21. Then, the control section 21 transmits, to the electronic cassette 13 housed in the universal stand 33, a signal for starting the imaging operation. During a time period from when this control is performed to when transmission/reception of the second information 102 is restarted, the second information 102 stored in the storage unit 23 is displayed together with the first information 101 on the display section 22. Meanwhile, even during this time period, as illustrated in FIG. 16A, the electronic cassettes 11 to 13 continuously transmit/receive the second information 102 to/from the stand display sections 34A to 34C, respectively. Accordingly, regarding the display contents displayed on each of the stand display sections 34A to 34C, the display contents in the latest state are continuously updated. This leads to an advantage that, during preparation for imaging, the user who performs a task mainly in the vicinity of the stand devices 31 to 33 can always grasp the states of the electronic cassettes 11 to 13 that are hidden in the stand device 31 to 33, respectively. Furthermore, in the case where each of the stand display sections 34A to 34C is configured as another unit that can be added on a corresponding one of the stand devices 31 to 33, particular alteration to each of the stand devices 31 to 33 is unnecessary. Thus, each of the stand display sections 34A to 34C can be easily installed in old equipment such as a stand device for a film cassette.

When an X-ray image has been acquired by the electronic cassette 13 and transmitted to the control section 21, display is performed on the display section 22 as illustrated in FIG. 16D. In other words, the acquired image and the operation menu that is necessary to check, process, and save the acquired image occupy the maximum region in the display screen. The state information indicating the states of the electronic cassettes 11 to 13 is displayed in a small region. When the control section 21 has received, from the electronic cassette 13, a notification indicating that the imaging operation has been completed, the control section 21 restarts transmission/reception of the second information 102 to/from all of the electronic cassettes 11 to 13. However, the control section 21 preferentially performs transmission/reception of the second information 102 to/from the electronic cassette 11 that is to be used in imaging for the next time and that is housed in the upright position stand 31. In response to this, the display contents in the row for the upright position stand 31 are preferentially updated, and also updated so that the visibility of the row for the upright position stand 31 is higher than that of the rows for the other electronic cassettes. Note that, in the case where it is determined that no electronic cassette is housed in the upright position stand 31, the control section 21 searches the second information 102, which is stored in the storage unit 23, for an electronic cassette that satisfies a condition where the electronic cassette is not housed in any stand device, a condition where the electronic cassette has a size that is equal to or larger than an imaging region which is necessary for imaging, a condition where the remaining capacity of the built-in battery is equal to or larger than a necessary capacity, and so forth. The control section 21 provides, for the user, guidance for prompting the user to house the electronic cassette in the upright position stand 31.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-279483, filed on Dec. 21, 2012, which is hereby incorporated by reference herein in its entirety.

What is claimed is:

1. An X-ray imaging apparatus comprising:
a plurality of X-ray detection cassettes; and
an information processing section configured to communicate with the plurality of X-ray detection cassettes and to process information concerning a state of the plurality of X-ray detection cassettes,
wherein each of the plurality of X-ray detection cassettes transmits/receives, to/from the information processing section, first information based on an image control signal and image data of the X-ray detection cassette and second information that is different from the first information, and
wherein, in a case where a time at which the first information is transmitted/received and a time at which the second information is transmitted/received coincide with each other, the first information is preferentially transmitted/received.

2. The X-ray imaging apparatus according to claim 1,
wherein the information processing section is a display section configured to display the information concerning the state of the plurality of X-ray detection cassettes.

3. The X-ray imaging apparatus according to claim 1,
wherein the information processing section is a control section configured to control operations of the plurality of X-ray detection cassettes, and the control section includes a display unit configured to display the first information or the second information.

4. The X-ray imaging apparatus according to claim 3,
wherein the control section includes a storage unit configured to store therein the first information or the second information.

5. The X-ray imaging apparatus according to claim 1,
wherein the second information is state information indicating states of the plurality of X-ray detection cassettes.

6. The X-ray imaging apparatus according to claim 5,
wherein each of the plurality of X-ray detection cassettes includes a battery and a wireless communication unit, and the state information is information concerning the X-ray detection cassette,
wherein the state information includes at least one of position information indicating a position of the X-ray detection cassette, a driving state of the X-ray detection cassette, a state of the battery, and a communicate state.

7. The X-ray imaging apparatus according to claim 6,
wherein each of the plurality of X-ray detection cassettes includes a position detection unit configured to the position information.

8. The X-ray imaging apparatus according to claim 6, further comprising
a plurality of stand devices, each of the stand devices being configured to hold at least one of the plurality of X-ray detection cassettes so that the X-ray detection cassette is detachably attached to the stand device,
wherein the position information is combination information indicating a combination of one of the plurality of X-ray detection cassettes and one of the stand devices, and each of the plurality of X-ray detection cassettes includes a unit configured to detect a combination of the X-ray detection cassette and one of the stand devices.

9. The X-ray imaging apparatus according to claim 6,
wherein the state of the battery is the remaining capacity of the battery or the number of times the battery has been charged.

10. The X-ray imaging apparatus according to claim 6,
wherein the communication state is a field intensity in wireless communication.

11. The X-ray imaging apparatus according to claim 6,
wherein the battery of each of the plurality of X-ray detection cassettes is capable of being charged by power supplied from an external power source, and the state of the battery includes a charging state of the battery.

12. The X-ray imaging apparatus according to claim 6,
wherein each of the plurality of X-ray detection cassettes is capable of communicating with the information processing section via a wired connection, and the communication state includes a state of the wired connection.

13. The X-ray imaging apparatus according to claim 2,
wherein the control section transmits, to a certain X-ray detection cassette among the plurality of X-ray detection cassettes, a signal for preparation for an imaging operation, and controls the plurality of X-ray detection cassettes including the certain X-ray detection cassette so that the plurality of X-ray detection cassettes will not transmit the second information.

14. The X-ray imaging apparatus according to claim 2,
wherein the control section transmits, to the plurality of X-ray detection cassettes, a signal indicating that an imaging operation is to be performed by a certain X-ray detection cassette among the plurality of X-ray detection cassettes, and each of the X-ray detection cassettes that have received the signal stops transmission of the second information to the information processing section.

15. The X-ray imaging apparatus according to claim 14,
wherein, in a case where the information processing section transmits a communication prohibition signal, the information processing section acquires the state information indicating the states of the plurality of X-ray detection cassettes.

16. The X-ray imaging apparatus according to claim 13,
wherein, when transmission of image data has been completed, the certain X-ray detection cassette transmits, to the control section, a notification indicating that imaging has finished, and, when the control section receives the notification indicating that imaging has finished, the control section removes a restriction on transmission of the second information from the plurality of X-ray detection cassettes.

17. The X-ray imaging apparatus according to claim 13,
wherein, when the certain X-ray detection cassette detects that transfer of image data has been completed, the certain X-ray detection cassette restarts transmission/reception of the second information to/from the information processing section.

18. The X-ray imaging apparatus according to claim 15,
wherein, when transfer of image data has been completed, the certain X-ray detection cassette transmits, to the control section, a notification indicating that imaging has finished, and, when the control section receives the notification indicating that imaging has finished, the control section transmits, to the plurality of X-ray detection cassettes, a communication restart signal for removing a restriction on communication.

19. An X-ray imaging apparatus comprising:
an X-ray detection cassette; and
an information processing section configured to communicate with the X-ray detection cassette and to process information concerning the X-ray detection cassette,
wherein the X-ray detection cassette communicates with the information processing section so that first information corresponding to image data is transmitted/received to/from the information processing section in preference to second information different from the first information.
